(19) United States
(12) Patent Application Publication
(10) Pub. No.: US 2006/0286960 A1
(43) Pub. Date: Dec. 21, 2006

(54) Wireless patient pendant system and method

(76) Inventor: Rolf Goehler, Schaumburg, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/154,521

(22) Filed: Jun. 17, 2005

(51) Int. Cl. H04Q 7/20; H04H 1/00

(52) U.S. Cl. 455/403; 455/3.05

(57) ABSTRACT

A communications and remote control system is provided for a patient. The system includes a portable wireless patient pendant having a transmitting unit which sends a wireless staff call signal, a wireless patient voice signal, and a wireless entertainment module control signal. The wireless patient pendant also includes a receiving unit which receives a wireless staff response signal and a wireless entertainment audio signal. The system further includes a patient station having a receiving unit which receives the wireless staff call signal. The patient station also includes an intercom unit which receives the patient voice signal and transmits a wireless staff response signal. The system also includes an interface unit for coupling to a smart television. The interface unit includes a receiving unit which receives the wireless entertainment module control signal and a transmitting unit which transmits the wireless entertainment audio signal.

### CROSS-REFERENCE TO RELATED APPLICATIONS

None.

### FIELD OF THE INVENTION

The present invention relates generally to electronics and communications devices. More particularly, the present invention relates to systems and methods for electronic communications in a hospital environment.

### BACKGROUND OF THE INVENTION

This invention concerns communications technology for patient care in a medical facility environment. In a medical care facility, a patient must generally be monitored by the medical staff at all times to ensure prompt care and attention. Yet a patient in a hospital environment is generally confined to a hospital bed or hospital room, having little mobility and ability to move or handle objects or equipment. It is therefore difficult for a patient to communicate with medical staff when a condition arises and the patient must be attended to by a doctor or nurse.

A call forwarding and signaling system is commonly used in medical facilities today, wherein a patient may press a button on a console or portable device which sends a signal to a remote station that can be viewed by the medical staff. This type of “nurse call” system is widely used, having numerous forms and implementations. The call signal from the patient can be sent to a remote station within or outside of the patient's hospital room. This remote station can have a number of communications systems, such as a speaker, intercom, audio and video communications means, and data transfer means. Alternatively, a more simple implementation of a nurse call system entails a system where the call signal can be sent to a domelight having a set of indicator lights which are color-coded. The domelights can be set up around the facility, in hallways, above doors, in treatment rooms, in medical staff offices, or command centers.

In addition to nurse call systems, which have a purpose of monitoring a patient in order to provide care and attention, an additional mode of communication utilized by a patient is for entertainment purposes. This generally means having a television or some other audio-visual entertainment device present in the room where the patient is located. A patient can generally control the television by means of a remote control device which is specially designed for the television.

However, current systems for use by patients have only limited functionality when it comes to utilizing a remote control for a television or communicating with medical staff through a nurse call system. Often the patient's control device or interface is tethered to a console or power supply source. Such a wired system limits a patient's mobility as well as the ease of use of the system. In addition, the patient's interface for communicating with the nurse call system and for communicating with television or entertainment system can be composed of separate devices or units. Furthermore, the patient interface may not be able to carry audio signals, such as an audio feed from the television, or from the patient station monitoring the patient in the nurse call system through which doctors and nurse may speak to the patient, and the patient may speak to the staff.

Accordingly, it is desirable to provide a method and system that provides for better patient control and communications with nurse call systems and entertainment systems in a hospital environment. It is also desirable to provide a method and system that provides for greater patient mobility when controlling and communicating with nurse call systems and entertainment systems in a hospital environment.

### SUMMARY OF THE INVENTION

The foregoing needs are met, to a great extent, by the present invention, wherein in one aspect a system and method is provided that in some embodiments provides for enhanced patient control, mobility and communications with medical staff call and signaling systems and patient entertainment systems in a hospital or similar medical facility.

In accordance with one embodiment of the present invention, a communications and remote control system is provided for a patient. The system includes a portable wireless patient pendant having a transmitting unit which sends a wireless staff call signal, a wireless patient voice signal, and a wireless entertainment module control signal. The wireless patient pendant also includes a receiving unit which receives a wireless staff response signal and a wireless entertainment audio signal. The system further includes a patient station having a receiving unit which receives the wireless staff call signal. The patient station also includes an intercom unit which receives the patient voice signal and transmits a wireless staff response signal. The system also includes an interface unit for coupling to a smart television. The interface unit includes a receiving unit which receives the wireless entertainment module control signal and a transmitting unit which transmits the wireless entertainment audio signal.

In accordance with another embodiment of the present invention, a communications and remote control system for a patient is provided. The system includes a portable patient pendant having a transmitting unit which sends a wireless staff call signal, a wireless patient voice signal, and a first wireless entertainment module control signal. The portable patient pendant also includes a receiving unit which receives a wireless staff response signal and a first wireless entertainment audio signal. The system also includes a patient station having a receiving unit which receives the wireless staff call signal. The patient station includes an intercom unit which receives the patient voice signal and transmits the wireless staff response signal. The patient station also includes a first signal forwarding unit which receives the first wireless entertainment module control signal and transmits a second wireless entertainment module control signal. The patient station further includes a second signal forwarding unit which receives a second wireless entertainment audio signal and transmits the first wireless entertainment audio signal. The system includes a power cable coupling the patient station and the patient pendant, and an interface unit for coupling to a smart television. The interface unit includes a receiver which receives the second wireless entertainment module control signal and a transmitter which transmits the second wireless entertainment audio signal.

In accordance with yet another aspect of the present invention, a method of remote control and communications for a patient is provided. In the method, a wireless staff call signal, a wireless patient voice signal, and a wireless entertainment module control signal are all sent from a portable wireless patient pendant. A wireless staff response signal and a wireless entertainment audio signal are received on the patient pendant. The wireless staff call signal is received from the patient pendant on a patient station. A wireless staff response signal is received and transmitted through an intercom unit on the patient station. The wireless entertainment module control signal is received on an interface unit for coupling to a smart television. The wireless entertainment audio signal is transmitted from the interface unit to the patient pendant.

In accordance with still another aspect of the present invention, a method of remote control and communications for a patient is provided. In the method, a wireless staff call signal, a wireless patient voice signal, and a wireless entertainment module control signal is sent from a portable wireless patient pendant. A wireless staff response signal and a wireless entertainment audio signal are received on the patient pendant. The wireless staff call signal is received from the patient pendant on a patient station. A wireless staff response signal is received and transmitted through an intercom unit on the patient station. The wireless entertainment module control signal is received from the patient pendant on the patient station and the wireless entertainment module control signal is transmitted from the patient station to an interface unit for coupling to a smart television. The wireless entertainment module control signal is received from the patient station on the interface unit. And, in addition, the wireless entertainment audio signal is transmitted from the interface unit to the patient pendant through the patient station.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic representation illustrating a patient remote control and communications system according to a first embodiment of the invention.

FIG. 2 is a schematic representation illustrating a patient remote control and communications system according to a second embodiment of the invention.

FIG. 3 is a schematic representation illustrating the patient remote control and communications systems shown in FIG. 1 or 2 in a mobile mode as used by a patient in a hospital.

### DETAILED DESCRIPTION

The invention will now be described with reference to the drawing figures, in which like reference numerals refer to like parts throughout. An embodiment in accordance with the present invention provides a communications and remote control system for a patient. The system includes a portable wireless patient pendant which can send a number of signals to communicate with medical staff and to control a television or other entertainment unit in the patient's hospital room. The wireless patient pendant also receives any staff response signal and an audio signal from the entertainment module. All signals are sent and received wirelessly. The system further includes a patient station having a receiving unit which receives any wireless staff call signal from the patient pendant. The patient station also includes an intercom unit which receives a patient voice signal transmitted from the pendant. The medical staff can respond to a patient call by transmitting a staff response signal through the patient station. All communications between the pendant and the patient station are wireless. The system can also include an interface unit for coupling to a smart television, which can be a part of the entertainment system in the patient's hospital room. The interface unit includes a receiving unit which receives a wireless entertainment module control signal sent from the patient pendant and transmits a wireless entertainment audio signal back to the pendant, to which the patient can listen through an audio broadcasting means on the pendant.

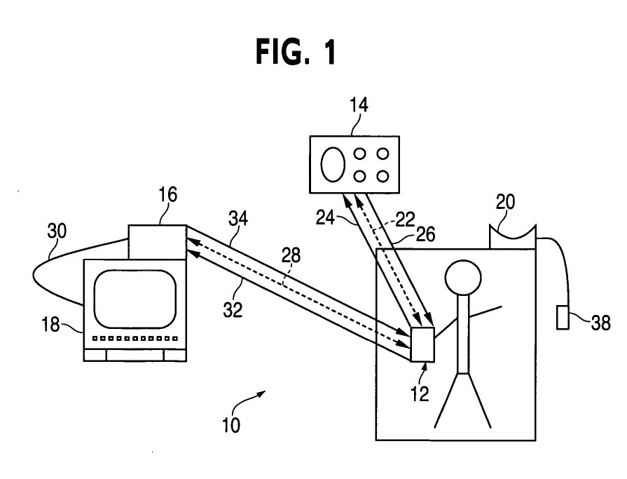

An embodiment of the present inventive system and method is illustrated in FIG. 1. The system 10 includes a wireless patient pendant 12, a patient station 14, an interface unit 16, an entertainment unit or module 18, and a recharging cradle 20. As used herein, the term “pendant” shall mean any portable small device suitable for being held and manipulated by a patient. The pendant may be hand-held or smaller, and can include a number of sub-systems or components that are known in the art. Included among these subsystems are display, such as an LED or liquid crystal display, as well as a number of switches or data input buttons or keys. The pendant can also include wireless signal receiving and sending means, a microphone, and an audio broadcasting means such as a speaker or a headphone or audio line out port. Also included would be any processing means for processing or transferring a received signal and sending a corresponding signal derived from the received signal. One example would be receiving a patient's voice through the microphone and converting the voice to an electrical signal, and then converting the electrical signal to an RF wireless signal.

Furthermore, as used herein, the term “wireless signal” shall mean an electromagnetic signal that is transmitted without a cable, wire, or structural carrier. The wireless signal may be radiofrequency (RF), microwave, infrared, visible light, laser light, or some other electromagnetic wave or particle stream. As used herein, the term “transmitting unit” shall mean any architecture that can generate, process, encode, and send a wireless signal, while a “receiving unit” shall mean any architecture that can process, decode and receive a wireless signal, as such units are well known in the art. Each of the transmitting unit and receiving unit can include one or several individual transmitters, receivers, processors, encoders, decoders, and the like, such that any transmitting unit or receiving unit can be composed of any combination of the afore-mentioned components, as is well known to those of ordinary skill in the art.

The patient pendant 12 includes both a transmitting unit and a receiving unit. The pendant 12, acting through its transmitting unit and receiving unit, can communicate using a first wireless signal path 22, such as an RF signal path, to the patient station 14. The first wireless signal path 22 can include a number of transmitted signals 24 and a number of received signals 26. The transmitted signals 24 include a wireless staff call signal, and a wireless patient voice signal. The received signals 26 could be a voice response when the staff performs an intercom connection with the patient to find out issues without having to go to the room immediately. And, signals 26 could include an acknowledgement signal to the staff call signal, to indicate to the patient that the staff call signal was properly sent in the system, where the acknowledgement signal could be configured to activate=an indicator on the patient pendant 12, like lighting a LED on the pendant device. The received signals 26 may therefore be a mixture of multiple signals, carrying both voice and data.

A wireless staff call signal is any signal that is encoded and arranged to signal to medical staff a particular condition, such as an emergency or request for care or attention. These signals are similar to those used in nurse call systems, and can vary according to a pre-determined meaning. The patient can select a particular type of wireless staff call signal by pressing a particular key or button on the patient pendant 12. A wireless patient voice signal is any signal that carries the voice of a patient, as such voice is spoken by the patient into a microphone on the patient pendant 12. This signal can serve as a means of communications between the patient and the hospital staff.

Both the wireless staff call signal and the wireless patient voice signal are received by the patient station 14. A patient station 14 is a remote data processing and signal relay station that acts as the intermediate point where patient and medical staff communications can meet. The patient station 14 include one or more transmitting and receiving units as well as an intercom unit, which received the wireless patient voice signal and can transmit a wireless staff response signal back to the pendant 12 through the signal path 22, thereby enabling the patient and staff to talk to one another. The wireless staff response signal can also include non-voice encoded data, such as a signal that serves as a response corresponding to the wireless staff call signal sent from the patient. An example of this would be a response indicator on the patient pendant that would light up or show a response message when a nurse call is initiated by the patient through the sending of a staff call signal.

Also included along the first signal path is a wireless heartbeat signal sent from a transmitter in the patient station to the patient pendant to monitor the integrity of the patient pendant. This monitoring would be done periodically and would conform to regulatory requirements. The heartbeat signal can be initiated by the wireless patient pendant and/or the patient station, but it is thereafter acknowledged by the signal receiving device otherwise a system alert is initiated that the wireless patient pendant is not functional and could prevent the patient from signaling for help.

A second wireless signal path 28 is provided between the patient pendant 12 and an interface unit 16. The interface unit 16 can be a set-top box that connects with an entertainment module 18 through a cable 30 such as a serial connector. The entertainment module 18 can be a television, radio, music player, or similar device. The television can be a smart television having a number of digital input and output ports and functionalities, as is well known in the art. As used herein, the term “interface unit” shall mean any interface that converts the wireless control and audio signals discussed herein to communicate with an entertainment module such as a television, radio or radio channel, video or media player, and the like. Interface unit 16 is such a television interface unit.

The set-top box interface unit 16 can connect to the smart television 18 to control functions like power on/off, channels, levels, etc. Each of these functions could be controlled by a entertainment module control signal 32 sent wirelessly from the patient pendant 12 to the interface unit 16. In return, a entertainment audio signal 34 carrying the audio broadcast from the entertainment unit 18, such as a television, could be sent wirelessly from the interface unit 16 to the patient pendant 12.

All wireless signals discussed above can be implemented using the Bluetooth wireless standard and associated technology, as is well-known to those of ordinary skill in the art. The Bluetooth technology would cover the transmitting and receiving units in the patient pendant 12, the patient station 14 and the interface unit 16. However, it is understood that Bluetooth is not the only implementation that could be used in accordance with the present invention, and alternative technologies using other wireless spectrum or signal processing means, such as infrared, or another RF band, can be used to provide the necessary wireless communications means used by the components of the present system.

A battery would be included in the patient pendant 12, such that a low-battery message indicator on the patient pendant would displays a low-battery message when the battery reaches a low-power condition. A shut-off circuit in the patient pendant 12 would then prevent the patient pendant 12 from sending the wireless entertainment module control signal and from receiving the wireless entertainment audio signal when the battery reaches the low-power condition. The low-power condition can be any pre-determined measure of charge or power in a battery to trigger the low-battery message. Such a message can be any effective communication to a patient through a low-battery message indicator, such as a display, or LED indicator. When the low-battery condition is reached, the patient may recharge the pendant via a recharging cradle 20 placed in reach of the patient, which may have an extension or port 38 for ease of use.

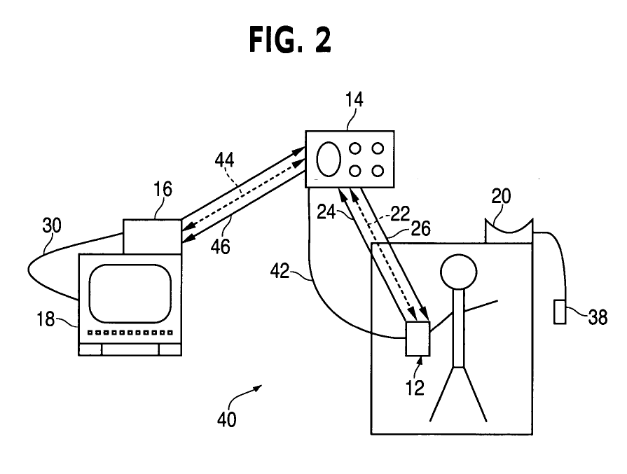

FIG. 2 is a schematic representation illustrating a patient remote control and communications system 40 according to a second embodiment of the invention. This embodiment is similar to the first embodiment shown in FIG. 1, except that the patient station 14 acts as an intermediate relay point transmitting and receiving signals from the interface unit 16 to the patient pendant 12. Furthermore, the patient pendant is, while still portable, not completely wireless and includes a power cable or coupling 42 which enables the pendant to retain power and charge for a greater length of time, without having to be recharged or powered up.

Furthermore, in system 40, a new signal path 44 exists between the interface unit 16 and the patient station 14, where a second wireless entertainment module control signal 46 is sent by the patient station 14 via signal forwarding unit therein, which forwards and relays a first wireless entertainment module control signal 24 sent from the patient pendant 12 to the patient station 14. Similarly, the first wireless entertainment audio signal 26 sent from the patient station 14 to the pendant 12 is forwarded and relayed by another signal forwarding unit in the patient station 14, from a second wireless entertainment audio signal sent by the interface unit 16.

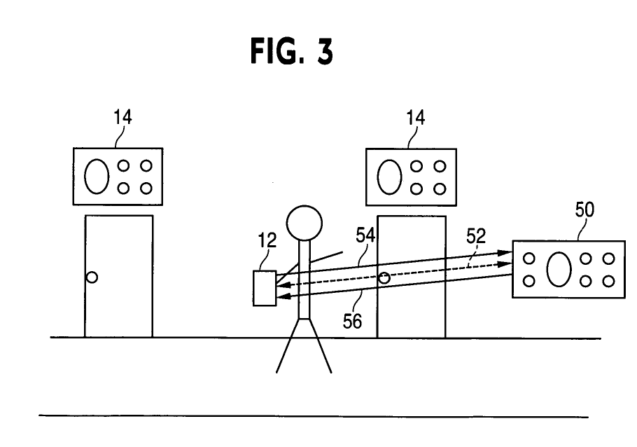

The present invention is advantageous in that it allows for reduced installation costs through less wiring, and improves the patient's mobility in his or her hospital room. In this way it effectively extends the ward area in which the patient can travel and move, while staying connected to the nurse call and entertainment functionalities in the hospital. The present invention could also be used in sub-acute care settings for the elderly, who require greater mobility, but can also benefit from the audio broadcasting of programs or can place emergency assistance calls when necessary. FIG. 3 is a schematic representation illustrating the patient remote control and communications systems shown in FIG. 1 or 2 in a mobile mode as used by a patient in a hospital. Here the pendant 12 can be carried by the patient and can communicate with a number of patient stations 14 over a particular door or room, or with a duty station 50 in the central areas of the hospital or corridor therein. The duty station would have similar functionalities as a patient station 14, via a wireless signal path 52 and sending and receiving signals 56 and 54, respectively, which could carry wireless patient voice signals and staff call signals, as well as entertainment audio signals.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A communications and remote control system for a patient, comprising:
a portable wireless patient pendant having a transmitting unit which sends a wireless staff call signal, a wireless patient voice signal, and a wireless entertainment module control signal, and a receiving unit which receives a wireless staff response signal and a wireless entertainment audio signal;
a patient station having a receiving unit which receives the wireless staff call signal, and an intercom unit which receives the wireless patient voice signal and transmits a wireless staff response signal; and
an interface unit for coupling to an entertainment module and having a receiving unit which receives the wireless entertainment module control signal and a transmitting unit which transmits the wireless entertainment audio signal.

2. The system of claim 1, further comprising:
a monitor unit in the patient station having a transmitter which sends a wireless heartbeat signal to the patient pendant to monitor the integrity of the patient pendant.

3. The system of claim 1 further comprising:
a battery in the patient pendant,
a low-battery message indicator on the patient pendant which displays a low-battery message when the battery reaches a low-power condition, and
a shut-off circuit in the patient pendant which prevents the patient pendant from sending the wireless entertainment module control signal and from receiving the wireless entertainment audio signal when the battery reaches the low-power condition.

4. The system of claim 3, wherein the shut-off circuit further prevents the patient pendant from receiving the wireless staff response signal when the battery reaches the low-power condition.

5. The system of claim 4, wherein the shut-off circuit further prevents the patient pendant from sending the wireless patient voice signal when the battery reaches the low-power condition.

6. A communications and remote control system for a patient, comprising:
a portable patient pendant having a transmitting unit which sends a wireless staff call signal, a wireless patient voice signal, and a first wireless entertainment module control signal, and a receiving unit which receives a wireless staff response signal and a first wireless entertainment audio signal;
a patient station having a receiving unit which receives the wireless staff call signal, an intercom unit which receives the patient voice signal and transmits the wireless staff response signal, a first signal forwarding unit which receives the first wireless entertainment module control signal and transmits a second wireless entertainment module control signal, and a second signal forwarding unit which receives a second wireless entertainment audio signal and transmits the first wireless entertainment audio signal;
a power cable coupling the patient station and the patient pendant; and
an interface unit for coupling to a smart television and having a receiver which receives the second wireless entertainment module control signal and a transmitter which transmits the second wireless entertainment audio signal.

7. The system of claim 6, further comprising:
a monitor unit in the patient station having a transmitter which sends a wireless heartbeat signal to the patient pendant to monitor the integrity of the patient pendant.

8. The system of claim 6 further comprising:
a battery in the patient pendant,
a low-battery message indicator on the patient pendant which displays a low-battery message when the battery reaches a low-power condition, and
a shut-off circuit in the patient pendant which prevents the patient pendant from sending the first wireless entertainment module control signal and from receiving the first wireless entertainment audio signal when the battery reaches the low-power condition.

9. The system of claim 8, wherein the shut-off circuit further prevents the patient pendant from receiving the wireless staff response signal when the battery reaches the low-power condition.

10. The system of claim 8, wherein the shut-off circuit further prevents the patient pendant from sending the wireless patient voice signal when the battery reaches the low-power condition.

11. A method of remote control and communications for a patient, comprising:
sending a wireless staff call signal, a wireless patient voice signal, and a wireless entertainment module control signal from a wireless patient pendant,
receiving a wireless staff response signal and a wireless entertainment audio signal on the patient pendant;
receiving the wireless staff call signal from the patient pendant on a patient station,
receiving and transmitting a wireless staff response signal through an intercom unit on the patient station;
receiving the wireless entertainment module control signal on an interface unit for coupling to a smart television; and
transmitting the wireless entertainment audio signal from the interface unit to the patient pendant.

12. The method of claim 11, further comprising:
sending a wireless heartbeat signal to the patient pendant from a monitor unit in the patient station to monitor the integrity of the patient pendant.

13. The method of claim 11 further comprising:
displaying a low-battery message on a low-battery message indicator on the patient pendant when a battery in the patient pendant reaches a low-power condition, and
temporarily disabling the patient pendant from sending the wireless entertainment module control signal and from receiving the wireless entertainment audio signal when the battery reaches the low-power condition.

14. The system of claim 13, further comprising:
temporarily disabling the patient pendant from receiving the wireless staff response signal when the battery reaches the low-power condition.

15. The system of claim 13, further comprising:
temporarily disabling the patient pendant from sending the wireless patient voice signal when the battery reaches the low-power condition.

16. A method of remote control and communications for a patient, comprising:
sending a wireless staff call signal, a wireless patient voice signal, and a wireless entertainment module control signal from a portable patient pendant,
receiving a wireless staff response signal and a wireless entertainment audio signal on the patient pendant;
receiving the wireless staff call signal from the patient pendant on a patient station,
receiving and transmitting a wireless staff response signal through an intercom unit on the patient station;
receiving the wireless entertainment module control signal from the patient pendant on the patient station and transmitting the wireless entertainment module control signal from the patient station to an interface unit for coupling to a smart television;
receiving the wireless entertainment module control signal from the patient station on the interface unit; and
transmitting the wireless entertainment audio signal from the interface unit to the patient pendant through the patient station.

17. The method of claim 16, further comprising:
sending a wireless heartbeat signal to the patient pendant from a monitor unit in the patient station to monitor the integrity of the patient pendant.

18. The method of claim 16, further comprising:
displaying a low-battery message on a low-battery message indicator on the patient pendant when a battery in the patient pendant reaches a low-power condition, and
temporarily disabling the patient pendant from sending the wireless entertainment module control signal and from receiving the wireless entertainment audio signal when the battery reaches the low-power condition.

19. The system of claim 18, further comprising:
temporarily disabling the patient pendant from receiving the wireless staff response signal when the battery reaches the low-power condition.

20. The system of claim 18, further comprising:
temporarily disabling the patient pendant from sending the wireless patient voice signal when the battery reaches the low-power condition.
